(19) United States
(12) Patent Application Publication
(10) Pub. No.: US 2006/0104471 A1
(43) Pub. Date: May 18, 2006

(54) Headphone apparatus

(75) Inventors: Naotaka Tsunoda, Tokyo (JP); Keitaro Fujiwara, Tokyo (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 11/253,166

(22) Filed: Oct. 18, 2005

(30) Foreign Application Priority Data
Oct. 20, 2004 (JP) P2004-305908

(51) Int. Cl. H04R 25/00

(52) U.S. Cl. 381/374; 381/370; 381/379

(57) ABSTRACT

A headphone apparatus the acoustic characteristics of which can be easily changed in accordance with the type of content the user wants to listen to. An adjusting knob provided on the housing of the headphone apparatus is moved, closing an opening made in a baffle. As a result, an acoustic space defined by the inner side of the baffle and an ear pad is more closed, thus increasing the level of low-frequency components of the sound generated by a sound-generating unit. Hence, the acoustic characteristics of the apparatus can be easily changed as the user desires.

### CROSS-REFERENCE TO RELATED APPLICATIONS

The present application claims priority from Japanese Patent Application No. JP 2004-305908 filed on Oct. 20, 2004, the disclosure of which is hereby incorporated by reference herein.

### BACKGROUND OF THE INVENTION

The present invention relates to a headphone apparatus. More particularly, the invention relates to a headphone apparatus that is fit for use as a sealing type.

Among the conventional headphone apparatuses is one that has an acoustic opening in the housing located at the back of the speaker unit. When the acoustic opening is opened or closed, the apparatus changes from a sealing type to a open-air type, or from an open-air type to a sealing type. The acoustic characteristics of the headphone apparatus are thereby changed. (See, for example, Jpn. Pat. Appln. Laid-Open Publication No. 3-184499.)

Such a headphone apparatus has acoustic characteristics that enable the user to listen to the music played back from mainly CDs (compact discs) and MDs (Mini Discs) (trademark). Generally, the user enjoys listening to the music contents of the CDs and the like, through the headphone apparatus.

The headphone apparatus of this type can indeed have such acoustic characteristics that can serve as both an open-air type and a sealing type. However, its acoustic characteristics are appropriate only for listening to music. Therefore, the user who sees a movie wearing the headphone apparatus may feel that the low-frequency components generated by the apparatus, such as sound effects, are too weak.

With the headphone apparatus of this type, the component of intermediate-low frequency components (about 100 Hz), i.e., the minimum resonant frequencies of the speaker unit, can be increased in level even after the acoustic opening of the housing is switched from the closed state to the open state. However, the components of frequencies near the ultra-low frequencies (about 50 Hz), which are lower than the minimum resonant frequencies of the speaker unit, cannot be increased in level.

### SUMMARY OF THE INVENTION

This invention has been made in view of the above. An object of the invention is to provide a headphone apparatus whose acoustic characteristics can be easily changed with a simple operation in accordance with the type of content to which the user wants to listen.

To achieve the object, a headphone apparatus according to this invention includes a sound-generating unit having an inner side, an outer side and a vibrating disc provided on the inner side for generating sound; a baffle shaped like a disc and having an inner side and outer side, the baffle being interposed between the inner and outer sides of the sound-generating unit; an ear pad mounted on a circumference of the baffle and surrounding the sound-generating unit; a housing integrally formed with the baffle and covering the outer side of the baffle; an opening of a prescribed shape in the baffle and extending through the baffle, opening at both sides thereof; cover means having a shape similar to the shape of the opening for opening and closing the opening; and an adjusting knob provided on the housing or the baffle for causing the cover means to open or close the opening. An acoustic space defined by the inner side of the baffle and the ear pad is more closed when a user wearing the headphone apparatus moves the adjusting knob, causing the cover means to close the opening, thereby to increase the level of low-frequency components of the sound generated by the sound-generating unit. The acoustic characteristics of the apparatus can thus be easily changed as the user desires.

In the present invention, the cover means closes the opening as the user moves the adjusting knob. The acoustic space defined by the inner side of the baffle and the ear pad is thereby more closed, increasing the low-frequency components of the sound generated by the sound-generating unit. Thus, the user can easily change the acoustic characteristics of the headphone apparatus.

The nature, principle and utility of the invention will become more apparent from the following detailed description when read in conjunction with the accompanying drawings in which like parts are designated by like reference numerals or characters.

### BRIEF DESCRIPTION OF THE DRAWINGS

In the accompanying drawings:

FIG. 1 is a diagram representing the acoustic characteristics that a conventional headphone apparatus exhibits when the acoustic opening is opened, and the acoustic characteristics that the conventional headphone exhibits when the acoustic opening is closed;

FIG. 2A is a perspective view showing the outer appearance of a headphone apparatus according to an embodiment of the present invention;

FIG. 2B is a side view of the headphone apparatus shown in FIG. 2A;

FIG. 2C is a front view of the headphone apparatus shown in FIG. 2A;

FIG. 3 is a perspective view illustrating the housing of the headphone apparatus shown in FIG. 2A;

FIG. 4 is a perspective view depicting the front of the baffle;

FIGS. 5A and 5B are perspective views showing the back of the baffle;

FIG. 6 is a diagram explaining how to operate the adjusting knob;

FIGS. 7A and 7B are sectional views explaining how to open and close the flip;

FIGS. 8A and 8B are diagrams explaining how sound travels;

FIG. 9 is a diagram representing the acoustic characteristics the headphone apparatus has in the movie mode and the acoustic characteristic it has in the music mode; and

FIG. 10 is a diagram showing a headphone apparatus according to another embodiment of this invention.

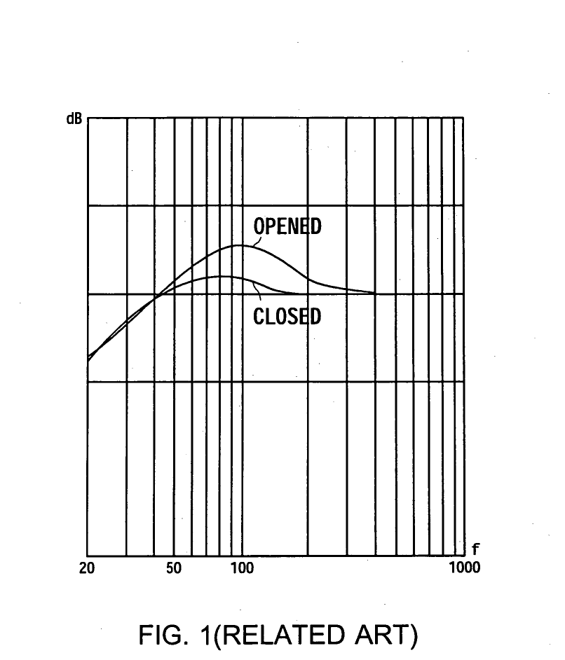

### DETAILED DESCRIPTION

An embodiment of the present invention will be described with reference to the accompanying drawings.

### (1) Outer Appearance of the Headphone Apparatus

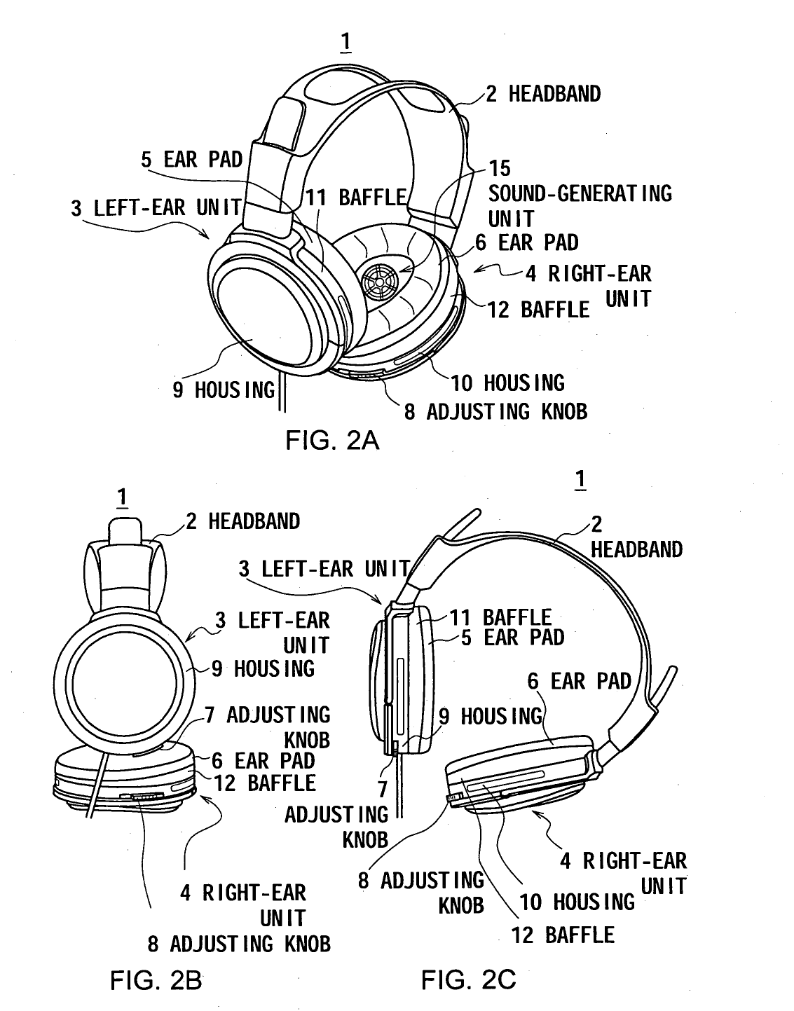

A headphone apparatus 1 according to an embodiment of this invention will be described, with reference to FIGS. 2A, 2B and 2C. As FIGS. 2A, 2B and 2C show, the headphone apparatus 1 includes a headband 2, a left-ear unit 3, a right-ear unit 4, and two ear pads 5 and 6. The left-ear unit 3 and the right-ear unit 4 are secured to the ends of the headband 2, respectively. The ear pads 5 and 6 are provided, respectively, on the inner sides of the left- and right-ear units 3 and 4, which oppose each other. The ear pads 5 and 6 cover a user's ears as long as the user wears the headphone apparatus 1.

The left-ear unit 3 includes a housing 9, a baffle 11 and a sound-generating unit 15. The sound-generating unit 15 is provided in the inner side of the left-ear unit and located at the center part thereof. The housing 9 functions as an acoustic space at the back of the sound-generating unit 15. The baffle 11, which is shaped like a disc, is interposed between the housing 9 and the ear pad 5 and holds the sound-generating unit 15. Like the left-ear unit 3, the right-ear unit 4 includes a housing 10, a baffle 12 and a sound-generating unit 15. The housing 10, baffle 12 and sound-generating unit 15 are assembled together in the same way as their counterparts of the left-ear unit 3.

The left- and right-ear units 3 and 4 have adjusting knobs 7 and 8, respectively. The adjusting knobs 7 and 8 are provided on the lower parts of the housings 9 and 10. The user may move the adjusting knobs 7 and 8 to set the headphone apparatus 1 to either the music mode or the movie mode.

If the user moves the adjusting knobs 7 and 8, changing the operating mode of the headphone apparatus 1, from the music mode to the movie mode, the low-frequency sound components will be emphasized.

### (2) Structure of the Housings

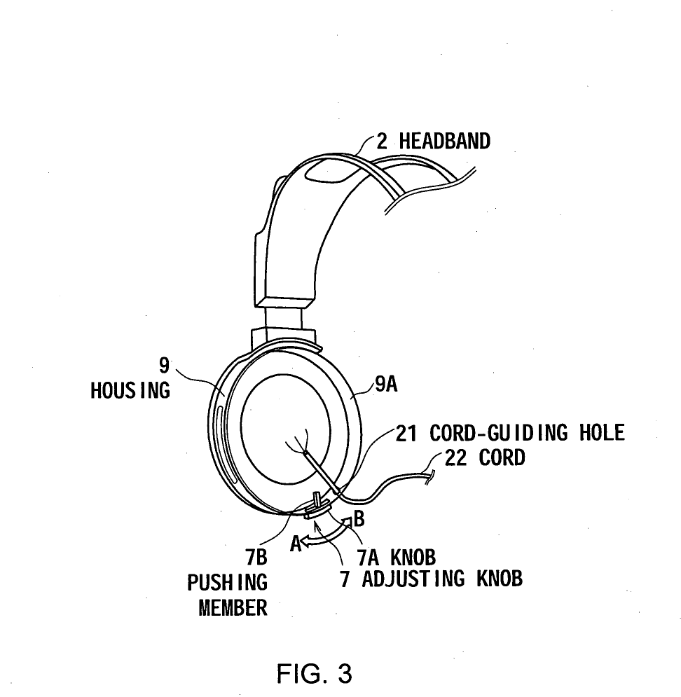

The housings 9 and 10 will be described in terms of their structure. The housings 9 and 10 are identical in structure, though they are shaped symmetrical to each other, one fitting on the left ear and the other fitting on the right ear. For simplicity of explanation, only the housing 9 of the left-ear unit 3 will be described with reference to FIG. 3.

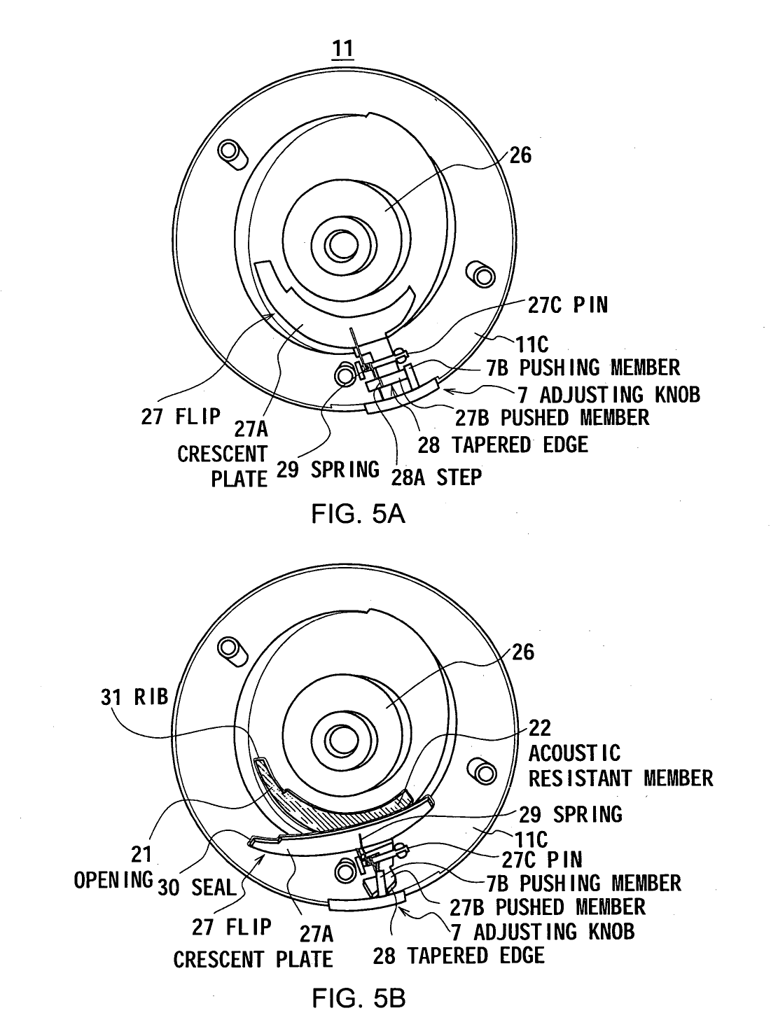

As FIG. 3 shows, the housing 9 defines a hollow and has a cord-guiding hole 21 in its circumference 9A. Through the hole 21, a cord 22 extends into the hollow. The cord 22 includes signal lines, which are connected to a speaker unit 26 (FIG. 5) secured to the baffle 11.

The adjusting knob 7 is provided on the circumference 9A of the housing 9. The adjusting knob 7 can be moved to switch the operating mode of the headphone apparatus 1, between the music mode and the movie mode. The adjusting knob 7 includes a knob 7A and a pushing member 7B, which are formed integrally. The knob 7A protrudes a little from the circumference 9A. The pushing member 7B, which is shaped like a rod, projects into the housing 9.

When the knob 7A is moved in the direction of arrow A or arrow B, the pushing member 7B moves within the housing 9 in the direction of arrow A or arrow B.

### (3) Structure of the Baffles

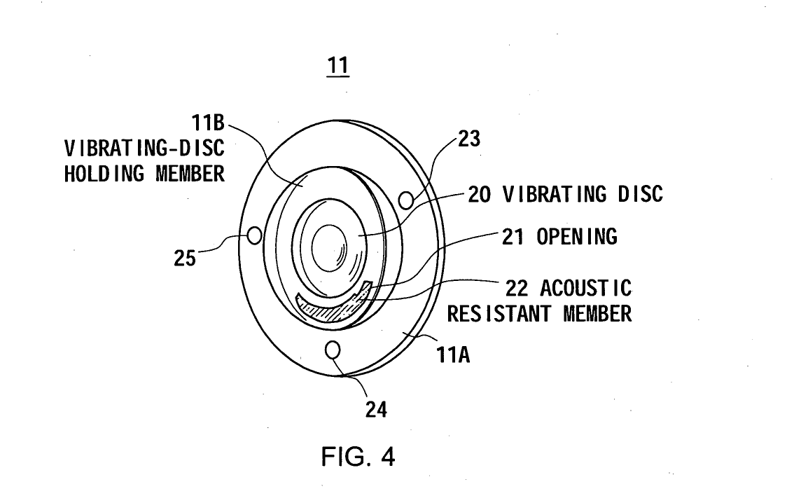

The baffles 11 and 12 will be described in terms of their structure. Like the housings 9 and 10, the baffles 11 and 12 are identical in structure, though they are shaped symmetrical to each other, one fitting on the left ear and the other fitting on the right ear. For simplicity of explanation, only the baffle 11 of the left-ear unit 3 will be described with reference to FIG. 4.

As FIG. 4 shows, the baffle 11 has a vibrating-disc holding member 11B. The member 11B is mounted on the front 11A of the baffle 11 and located at the center part thereof. The member 11B holds a vibrating disc 20 at its center part.

Once attached to the front 11A of the baffle 11, the ear pad 5 covers the front 11A, except the vibrating-disc holding member 11B. Only the vibrating disc 20 is exposed, though it is protected by a protective member (not shown).

The vibrating-disc holding member 11B has an opening 21 in its part that is not covered by the ear pad 5 attached to the front 11A of the baffle 11. The opening 21 is crescent, extending around a lower part of the vibrating disc 20. The opening 21 is covered with an acoustic resistant member 22, on the front 11A of the baffle 11. The member 22 is made of unwoven cloth and a little larger than the opening 21, restricting the passage of air through the opening 21. The function of the acoustic resistant member 22 will be described later.

Holes 23 to 25 are cut in the front 11A of the baffle 11, spaced from one another by a predetermined distance. Three screws (not shown) are driven into the holes 23 to 25, extending through three holes made in the housing 9. The housing 9 is thereby secured to the baffle 11.

As FIGS. 5A and 5B show, a flip 27 is provided on the back 11C of the baffle 11 and is located at the opening 21 made in the vibrating-disc holding member 11B. The flip 27 is similar in shape to the opening 21 and slightly larger than the opening 21. Thus, the flip 27 covers the opening 21. The flip 27 can be moved to open and close the opening 21.

The flip 27 includes a crescent plate 27A, a pushed member 27B and a pin 27C. The plate 27A and the pushed member 27B are formed integrally with each other. The pin 27C passes through the junction between the plate 27A and the member 28B. The unit composed of the plate 27A and the member 27B can therefore rotate around the pin 27C. Hence, the plate 27A can open and close the opening 21 made in the vibrating-disc holding member 11B.

As seen from FIG. 5B, the pushed member 27B has an edge 28 that is tapered at a prescribed angle. The pushing member 7B of the adjusting knob 7 provided on the housing 9 abuts on the tapered edge 28. As the knob 7A of the adjusting knob 7 is moved, the pushing member 7B pushes the tapered edge 28, the pushed member 27B of the flip 27 is gradually pushed. As the pushed member 27B is so pushed, the crescent plate 27A is rotated upward around the pin 27C, gradually opening the opening 21.

The tapered edge 28 of the pushed member 27B has a step 28A. When the pushing member 7B of the adjusting knob 7 moves to the step 28A as the user moves the adjusting knob 7, it makes the user feel a click. The pushing member 7B then rests at the step 28A. Therefore, the crescent plate 27A stays in the opening position.

A spring 29 is mounted on the pin 27, biasing the crescent plate 27A of the flip 27 in the closing position. A thin seal 30 made of soft felt is bonded to the inner side of the crescent plate 27A. The seal 30 is identical to the plate 27A in size and shape.

A rib 31 is provided at one end of the opening 21 of the baffle 11. The rib 31 has been formed by cutting a part of the vibrating-disc holding member 11B and bending this part from the back of the member 11B. When the seal 30 on the crescent plate 27A is pushed to the rib 31 by virtue of the bias of the spring 29, it bends a little, completely closing a gap, if any, between the opening 21 and the plate 27A.

### (4) Opening and Closing of the Flip

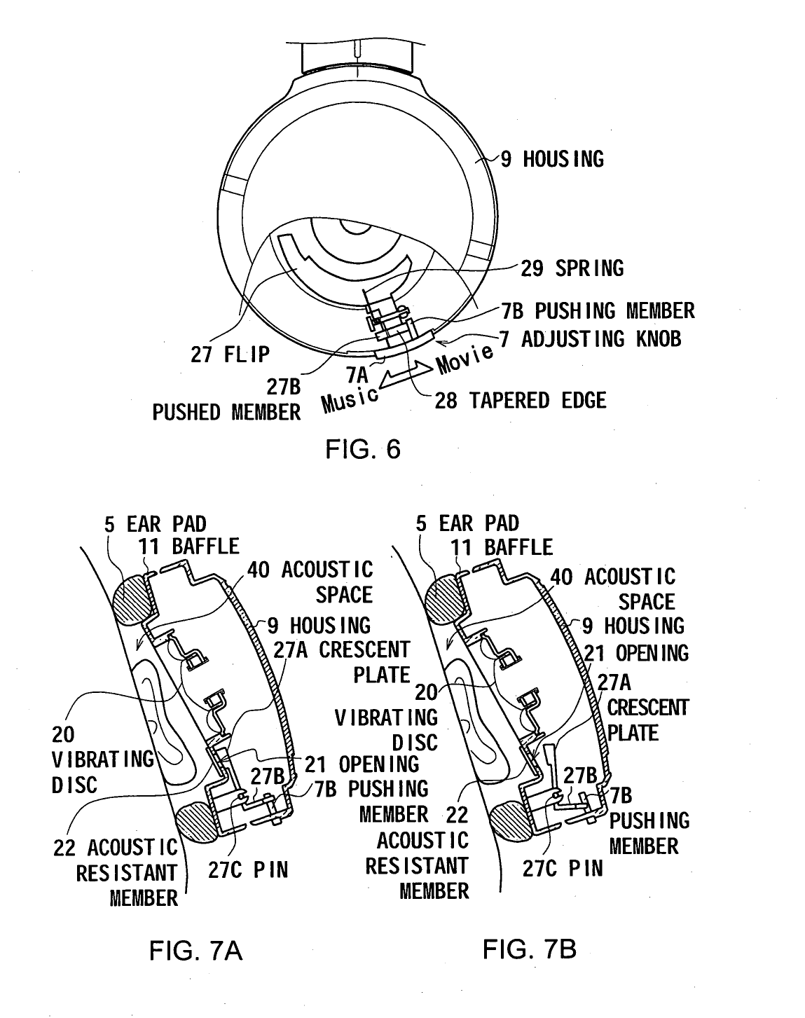

Assume that the knob 7A of the adjusting knob 7, which protrudes a little from the circumference 9A of the housing 9, is moved from “Movie” position to “Music” position (see FIG. 6). As the knob 7A is so moved, the pushing member 7B moves, pushing the edge 28 that is tapered.

As long as the knob 7A of the adjusting knob 7 stays at the “Movie” position as shown in FIG. 7A, the headphone apparatus 1 remains in the movie mode. In the movie mode, the crescent plate 27A of the flip 27 keeps closing the opening 21.

When the user moves the knob 7A from the “Movie” position to the “Music” position, the pushing member 7B moves, pushing down the tapered edge 28 of the pushed member 27B. The crescent plate 27A is thereby opened gradually.

When the pushing member 7B reaches the step 28A of the tapered edge 28, the crescent plate 27A is held in opened state as illustrated in FIG. 7B. Thus, the operating mode of the headphone apparatus 1 is switched from the movie mode to the music mode.

When the user moves the knob 7A from the “Music” position to the “Movie” position, the pushing member 7B moves along the tapered edge 28 in the opposite direction, allowing the spring 29 to move the crescent plate 27A onto the opening 21. As a result, the crescent plate 27A closes the opening 21.

In this case, the ear pad 5 covers the user's left ear, aligned with the center of the ear, when the user puts on the headphone apparatus 1. The acoustic space 40 defined by the ear pad 5 and the baffle 11 is far more closed by the crescent plate 27A of the flip 27 than in the music mode.

In the headphone apparatus 1, the seal 30 completely closes a gap, if any, between the rim of the opening 21 and the crescent plate 27. This greatly enhances the sealing of the acoustic space 40 in the movie mode.

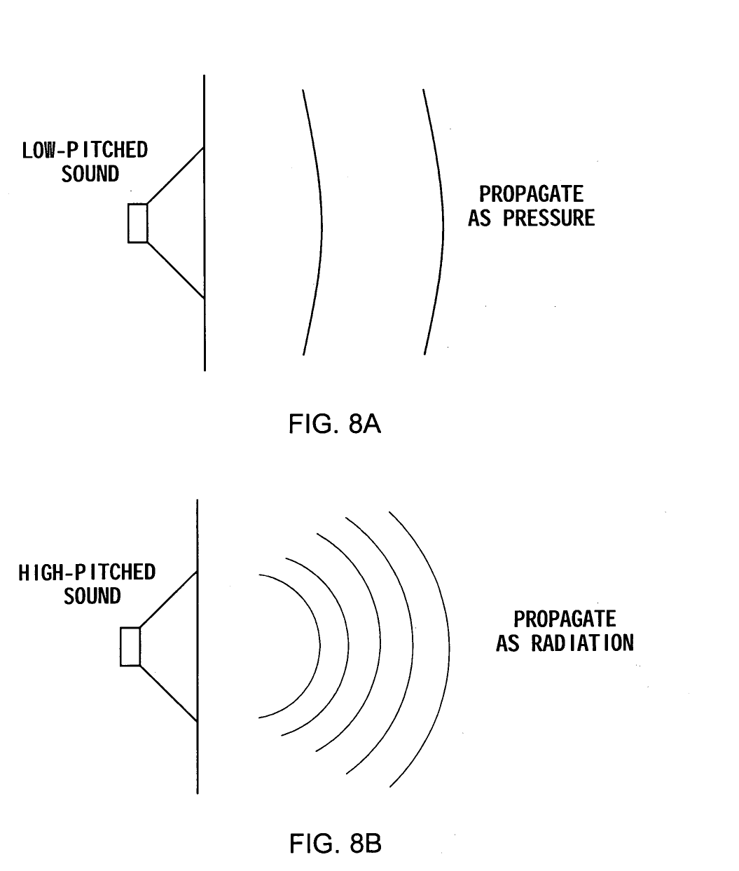

The sound generated by the vibrating disc 20 propagates in a specific manner as is known in the art. The low-frequency components of the sound propagate as a pressure as shown in FIG. 8A. This is because they have longer wavelengths than the intermediate- and high-frequency components and can therefore be regarded as straight lines, and because the distance between the vibrating disc 20 and the user's ear is short and the acoustic space 40 is tightly closed. By contrast, the intermediate- and high-frequency components propagate as a radiation as shown in FIG. 8B, because they have shorter wavelengths than the low-frequency components.

As long as the crescent plate 27A keeps closing the opening 21 as illustrated in FIG. 7A, the air at the vibrating disc 20 would not flow into the housing 11 through the opening 21. The vibration of the disc 20 propagates as an acoustic pressure, directly to the user's ear. The user can therefore hear the sound with its low-frequency components amplified.

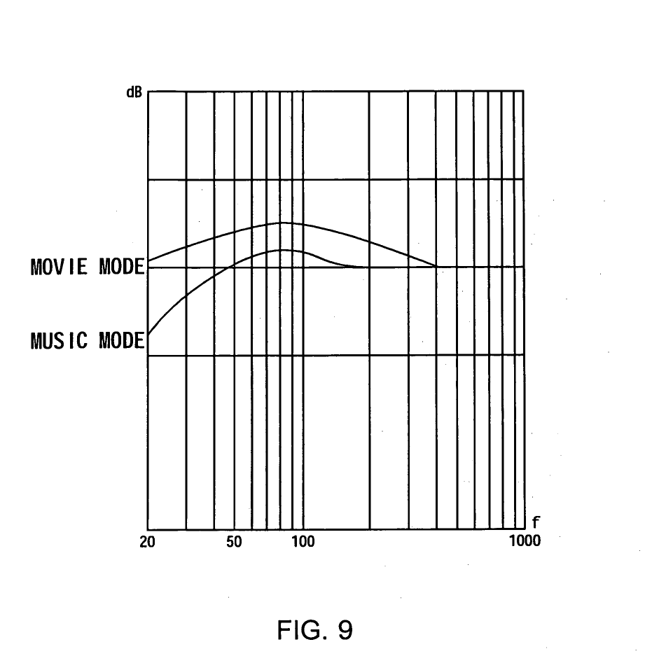

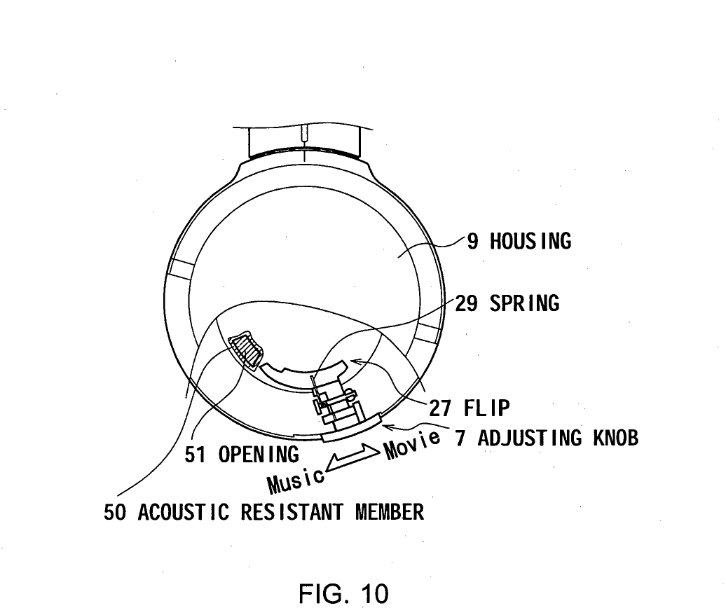

More precisely, as seen from FIG. 9, the low-frequency components are at a higher level, at frequencies of about 50 Hz when the headphone apparatus 1 is set in the movie mode than when it is set in the music mode.

The crescent plate 27A of the flip 27 never closes the opening 21 so long as the headphone apparatus 1 remains in the music mode. Nevertheless, the acoustic resistant member 22 prevents the low-frequency components from decreasing in level. This is because the acoustic resistant member 22 is bonded to the front 11A of the baffle 11 and covers the opening 21. Hence, the low-frequency components are maintained at a desired level in the music mode, balanced well with the intermediate-low frequency components. Thus, the headphone apparatus 1 can provide well-balanced, high-quality sound.

### (5) Operation and Advantages

When the user wearing the headphone apparatus 1 moves the adjusting knob 7, switching the operating mode to the movie mode form the music mode, the crescent plate 27A of the flip 27 closes the opening 21 made in the vibrating-disc holding member 11B of the baffle 11.

Once the opening 21 is so closed, the acoustic space 40 defined by the ear pad 5 and the front 11A of the baffle 11 becomes more closed than in the music mode. As a result, the low-frequency components generated increase in level. The acoustic characteristics of the headphone apparatus 1 change to those appropriate for the user to listen to speeches and sound effects of movies.

To change the acoustic characteristics of the apparatus 1 in accordance with the type of content (music or movie) the user wants to listen, the user needs only to move the adjusting knob 7 from the “Movie” position to “Music” position, or vice versa. The user need not operate an external apparatus, such as an equalizer, to adjust the frequency characteristics electrically as in the case of the conventional headphone apparatus.

The acoustic resistant member 22 bonded to the front 11A of the baffle 11 can cover the opening 21 to restrict the passage of air through the opening 21, thereby to provide a desirable acoustic resistance. The acoustic resistant member 22 therefore helps to maintain the acoustic space 40 in a closed condition even if the crescent plate 27A of the flip 27 remains open in the music mode. Hence, the headphone apparatus 1 can have acoustic characteristics for the music mode, maintaining the low-frequency components of sound at some magnitude.

Thus, the user can set the headphone apparatus 1 to optimum acoustic characteristics in accordance with the type of content which the user wants to listen, merely by sliding the adjusting knob 7 from one position to the other.

### (6) OTHER EMBODIMENTS

In the embodiment described above, the acoustic resistant member 22 is bonded to the front 11A of the baffle 11. This invention is not limited to this. The member 22 may be bonded to the back 11C of the baffle 11 instead.

In the embodiment described above, the vibrating-disc holding member 11B has, in its lower part, an opening 21 that is shaped almost crescent. This invention is not limited to this. A rectangular or circular opening may be made instead, in any other part of the vibrating-disc holding member 11B.

The vibrating-disc holding member 11B has only one opening 21 in the embodiment described above. The present invention is not limited to this. Instead, two or more opening may be made in the vibrating-disc holding member 11B. In this case, two or more flips are provided, each opening and closing one opening.

In the embodiment described above, the spring 29 biases the crescent plate 27A of the flip 27, making the plate 27A keep closing the opening 21. The invention is not limited to this. Rather, the spring 29 may bias the crescent plate 27A, causing the plate 27A keeps opening the opening 21. In this case, the plate 27 is pushed to close the opening 21.

In the embodiment described above, the plate 27A of the flip 27 can open and close the opening 21 made in the vibrating-disc holding member 11B. The invention is not limited to this. As shown in 10, another opening 51 may be made in the member 11B, in addition to the opening 21, and covered with an acoustic resistant member 50. In this case, the acoustic resistant member 50 cooperates with the acoustic resistant member 22 covering the opening 21, giving the headphone apparatus 1 such acoustic characteristic as cannot be attained by the acoustic resistant member 22 only.

The flip 27 closes the opening 21 in the embodiment described above. This invention is not limited to this. A sliding shutter may be used instead, to close the opening 21.

In the embodiment described above, the types of contents the user can listen to are limited to music and movie. This invention is not limited to this. Video games may be added to the contents. To listen to the sound effects of any video game, the user needs only to move the adjusting knob 7 to a “Game” position, causing the plate 27A to close the opening 21 thereby to increase the low-frequency components in level.

Further, in the embodiment described above, the operating modes are the music mode and the movie mode. The operating modes are not limited these in this invention. A jazz mode may be added, in which the opening 21 is closed to increase low-frequency components, enabling the user to enjoy listening jazz (i.e., a genre of music) well.

In the embodiment described above, the adjusting knob 7 is so arranged that the knob 7A protrudes from the circumference 9A of the housing 9. This invention is not limited to this, nonetheless. The adjusting knob 7 may be so positioned that the knob 7A may project from the circumference of the baffle 11.

As can be understood from the above, the present invention can provide a headphone apparatus that can be switched to one of various acoustic characteristics which the user has selected.

It should be understood by those skilled in the art that various modifications, combinations, sub-combinations and alternations may occur depending on design requirements and other factors insofar as they are within the scope of the appended claims or the equivalents thereof.

1. A headphone apparatus, comprising:
a sound-generating unit having an inner side, an outer side and a vibrating disc provided on the inner side for generating sound;
a baffle shaped like a disc and having an inner side and an outer side, the baffle being interposed between the inner and outer sides of the sound-generating unit;
an ear pad mounted on a circumference of the baffle and surrounding the sound-generating unit;
a housing integrally formed with the baffle and covering the outer side of the baffle;
an opening of a prescribed shape in the baffle and extending through the baffle, opening at both sides thereof;
cover means having a shape similar to the shape of the opening for opening and closing the opening; and
an adjusting knob provided on the housing or the baffle for causing the cover means to open or close the opening,
wherein an acoustic space defined by the inner side of the baffle and the ear pad is more closed when a user wearing the headphone apparatus moves the adjusting knob, causing the cover means to close the opening, thereby to increase the level of low-frequency components of the sound generated by the sound-generating unit.

2. The headphone apparatus according to claim 1, wherein an acoustic resistant member covers the opening to restrict the passage of air through the opening.

3. The headphone apparatus according to claim 1, wherein the opening is made in a part of the baffle other than the part on which the ear pad is mounted.

4. The headphone apparatus according to claim 2, wherein the opening is made in a part of the baffle other than the part on which the ear pad is mounted.

5. The headphone apparatus according to claim 1, wherein the baffle has a second opening covered with an acoustic resistant member which restricts the passage of air even when the cover means closes the opening.

6. The headphone apparatus according to claim 1, wherein the opening is substantially crescent-shaped.

7. The headphone apparatus according to claim 6, wherein the cover means is substantially crescent-shaped and is similar in shape to the opening.

8. The headphone apparatus according to claim 1, further comprising a pushed member for opening and closing the cover means, wherein the cover means opens or closes the opening when rotated as the pushed member is rotated.

9. The headphone apparatus according to claim 8, wherein the adjusting knob has a pushing member which abuts on the pushed member and pushes and moves the pushed member when the adjusting knob is operated, thereby to open or close the opening.

10. The headphone apparatus according to claim 8, wherein the pushed member has an edge tapered at a predetermined angle and has a step on the edge thus tapered.

11. A headphone apparatus, comprising:
a sound-generating unit having an inner side, an outer side and a vibrating disc provided on the inner side for generating sound;
a baffle shaped like a disc and having an inner side and an outer side, the baffle being interposed between the inner and outer sides of the sound-generating unit;
an ear pad mounted on a circumference of the baffle and surrounding the sound-generating unit;
a housing integrally formed with the baffle and covering the outer side of the baffle;
an opening of a prescribed shape in the baffle and extending through the baffle, opening at both sides thereof;
a cover having a shape similar to the shape of the opening and operable to open and close the opening; and
an adjusting knob provided on the housing or the baffle for causing the cover to open or close the opening,
wherein an acoustic space defined by the inner side of the baffle and the ear pad is more closed when a user wearing the headphone apparatus moves the adjusting knob, causing the cover to close the opening, thereby to increase the level of low-frequency components of the sound generated by the sound-generating unit.
